(19) United States
(12) Patent Application Publication
(10) Pub. No.: US 2022/0206353 A1
(43) Pub. Date: Jun. 30, 2022

(54) ELECTRO-OPTIC ELEMENT

(71) Applicant: GENTEX CORPORATION, Zeeland, MI (US)

(72) Inventors: George A. Neuman, Holland, MI (US); Yuping Lin, Zeeland, MI (US); Mario F. Saenger Nayver, Holland, MI (US); John S. Anderson, Holland, MI (US); Jeffery A. Forgette, Hudsonville, MI (US); Gary J. Dozeman, Zeeland, MI (US); Sheng Liu, Holland, MI (US)

(73) Assignee: GENTEX CORPORATION, Zeeland, MI (US)

(21) Appl. No.: 17/566,747

(22) Filed: Dec. 31, 2021

Related U.S. Application Data
(60) Provisional application No. 63/132,680, filed on Dec. 31, 2020.

(51) Int. Cl. G02F 1/155; G02F 1/1343; G02F 1/1333

(52) U.S. Cl. CPC G02F 1/155; G02F 1/13439; G02F 1/133305; G02F 1/134309

(57) ABSTRACT

An improved electro-optic element is disclosed. The electro-optic element may comprise a first substrate, a second substrate, a first electrode, a second electrode, and/or an electro-active medium. The first electrode may be associated with a surface of the first substrate. Likewise, the second electrode may be associated with a surface of the second substrate. The first and second substrates may be disposed in a substantially parallel, spaced apart relationship relative one another such that the first and second electrode face one another. The electro-active medium may be disposed between the first and second electrodes. Additionally, each of the first and second electrodes may comprise a conductive mesh and a layer. The layer may be electrically conductive and associated with an inner side of the mesh. Accordingly, the layer may serve as a lateral electrical distributor such that the electrical potential may be substantially uniform across the electrode.

### CROSS-REFERENCE TO RELATED APPLICATIONS

This application claims priority under 35 U.S.C. § 119(e) to U.S. Provisional Application No. 63/132,680 filed on Dec. 31, 2020, entitled “ELECTRO-OPTIC ELEMENT,” the disclosure of which is hereby incorporated by reference in its entirety.

### FIELD OF INVENTION

The present invention relates, in general, to electro-optic elements and, more particularly, to electro-optic elements having one or more mesh electrode.

### SUMMARY

In accordance with one aspect of the present disclosure, a device is disclosed. The device may comprise: a first flexible substrate, a second flexible substrate, a first electrode, a second electrode, and an electro-active medium. The first flexible substrate may have a first side and a second side. In some embodiments, first flexible substrate may be a conductive polymer. The second flexible substrate may have a third side and a fourth side. Further, the second flexible substrate may be disposed in a spaced apart relationship relative the first flexible substrate such that the third side faces the second side. The first electrode may be associated with the second side. Additionally, the first electrode may have a first electrically conductive mesh and a first substantially transparent, electrically conductive layer. The first electrically conductive mesh may be disposed, at least in part, within the first flexible substrate. In some embodiments, the first electrically conductive mesh has a fifth side and a sixth side and the sixth side may be substantially co-planar with the second side. In some embodiments, the first electrically conductive mesh may have an elongation failure of at least 5%. Additionally or alternatively, the first electrically conductive mesh may have an area reduction to rupture of at least 20%. The first substantially transparent, electrically conductive layer may be associated with the second side. In some embodiments, wherein the first substantially transparent, electrically conductive layer is disposed, at least in part, on the sixth side. Further, the first substantially transparent, electrically conductive layer may be at least one of TCO, IMI, conductive polymer, carbon nanotube, and silver nanowire materials. The second electrode may be associated with the third side. The electro-active medium may be disposed between the first and second electrodes. Additionally, the electro-active medium may be operable between an activated state and an un-activated state. In some embodiments, the electro-active medium may be electro-optic. In some such embodiments, the electro-active medium may be electrochromic.

In some embodiments, the second electrode may have a second electrically conductive mesh and a second substantially transparent, electrically conductive layer. The second electrically conductive mesh may be disposed, at least in part, within the second flexible substrate. Additionally, the second substantially transparent, electrically conductive may be layer associated with the third side. In some embodiments, the first flexible substrate substantially fully occupies one or more open areas of the first electrically conductive mesh.

In some embodiments, the device may further comprise a third substantially transparent substrate associated with the first side. In some such embodiments, a third layer may be disposed between the first substrate and the third substrate. Additionally or alternatively, a fourth substantially transparent substrate may be associated with the fourth side.

In accordance with another aspect of the present disclosure, a device is disclosed. The device may comprise: a first flexible substrate, a second flexible substrate, a first electrode, a second electrode, and an electro-active medium. The first flexible substrate may have a first side and a second side. The second flexible substrate may have a third side and a fourth side. Additionally, the second flexible substrate may be disposed in a spaced apart relationship relative the first flexible substrate such that the third side faces the second side. The first electrode may be associated with the second side. Additionally, the first electrode may have a first electrically conductive mesh, a first layer, and a second layer. The first electrically conductive mesh may have a fifth side and a sixth side. The first layer may be disposed between the first substrate and the first mesh. Further, the first layer may be substantially transparent. The second layer may be associated with the sixth side. Further, the second layer may be substantially transparent and electrically conductive. The second electrode may be associated with the third side. The electro-active medium may be disposed between the first and second electrodes. Additionally, the electro-active medium may be operable between an activated state and an un-activated state. In some embodiments, the electro-active medium may be electro-optic. In some embodiments, herein the first mesh may be disposed, at least in part, within the first layer. In some embodiments, the first layer may be a conductive polymer.

In some embodiments, the second electrode may have a second electrically conductive mesh, a third layer, and a fourth layer. The second electrically conductive mesh may have a seventh side and an eighth side. The third layer may be disposed between the second substrate and the second mesh. Additionally, the third layer being substantially transparent. The fourth layer may be associated with the seventh side. Further, the fourth layer may be substantially transparent and electrically conductive.

These and other aspects, objects, and features of the present disclosure will be understood and appreciated by those skilled in the art upon studying the following specification, claims, and appended drawings. It will also be understood that features of each embodiment disclosed herein may be used in conjunction with, or as a replacement for, features in other embodiments.

### BRIEF DESCRIPTION OF FIGURES

In the drawings:

FIG. 1: A cross-sectional schematic representation of an embodiment of an electro-optic element.

FIG. 2: A cross-sectional schematic representation of an embodiment of an electro-optic element.

FIG. 3: A cross-sectional schematic representation of an embodiment of an electro-optic element.

FIG. 4: A schematic representation of an embodiment of a wire mesh.

### DETAILED DESCRIPTION

The present disclosure is directed to an electro-optic element operable between a substantially activated state and a substantially un-activated state. The specific devices illustrated in the attached drawings and described in this disclosure are simply exemplary embodiments of the inventive concepts defined in the appended claims. Hence, specific dimensions and other physical characteristics relating the embodiments disclosed herein are not limiting, unless the claims expressly state otherwise.

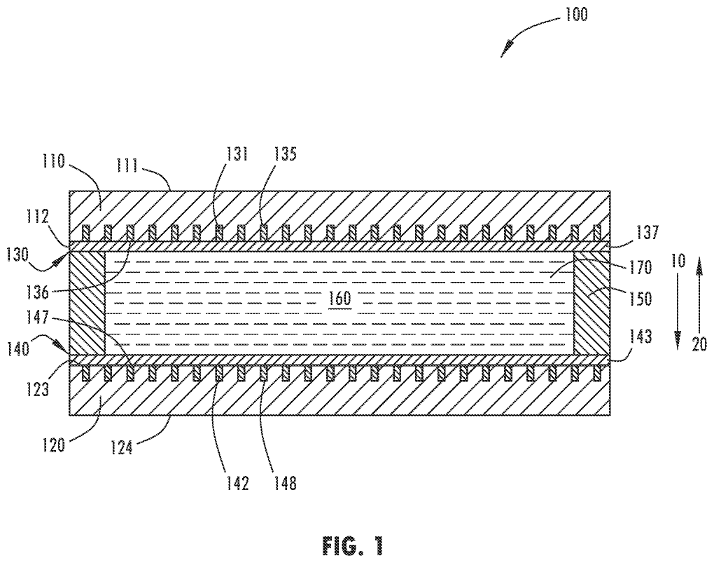

FIGS. 1-3 illustrate an electro-optic element 100. Electro-optic element 100 may comprise a first substrate 110, a second substrate 120, a first electrode 130, a second electrode 140, a seal 150, a chamber 160, and/or an electro-active medium 170. Further, electro-optic element 100 is operable between a substantially activated state and a substantially un-activated state. Operation between such states may correspond to a variable transmissivity of electro-optic element 100. In some embodiments, electro-optic element 100, for example, may be a window, a rearview assembly, a light filter, eyewear lens, or a sensor concealment device.

First substrate 110 is substantially transparent and has a first side 111 and a second side 112. First side 111 and second side 112 may be disposed opposite one another with second side 112 disposed in a first direction 10 relative first side 111. Further, first substrate 110 may be flexible. Accordingly, first substrate 110 may have a polymeric construction. For example, first substrate 110 may be comprised of: polyethylene (e.g., low and/or high density), polyethylene terephthalate (PET), polyethylene naphthalate (PEN), polycarbonate (PC), polysulfone, acrylic polymers (e.g., poly(methyl methacrylate) (PMMA)), polymethacrylates, polyimides, polyamides (e.g., a cycloaliphatic diamine dodecanedioic acid polymer (i.e., Trogamid® CX7323)), epoxies, cyclic olefin polymers (COP) (e.g., Zeonor 1420R), cyclic olefin copolymers (COC) (e.g., Topas 6013S-04 or Mitsui Apel), polymethylpentene, cellulose ester based plastics (e.g., cellulose triacetate), transparent fluoropolymer, polyacrylonitrile, other polymeric materials, and/or combinations thereof.

Similarly, second substrate 120 is substantially transparent and has a third side 123 and a fourth side 124. Third side 123 and fourth side 124 may be disposed opposite one another with fourth side 124 disposed in first direction 10 relative third side 123. Additionally, second substrate 120 may be disposed in first direction 10 in a spaced apart relationship relative first substrate 110. Thus, third side 123 may face second side 112. Further, second substrate 120 may be flexible. Accordingly, second substrate 120 may be comprised of the same or similar materials suitable for first substrate 130.

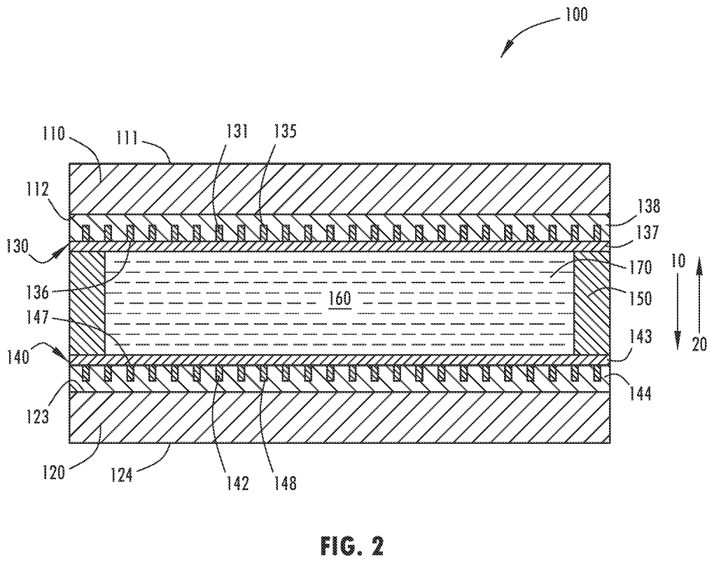

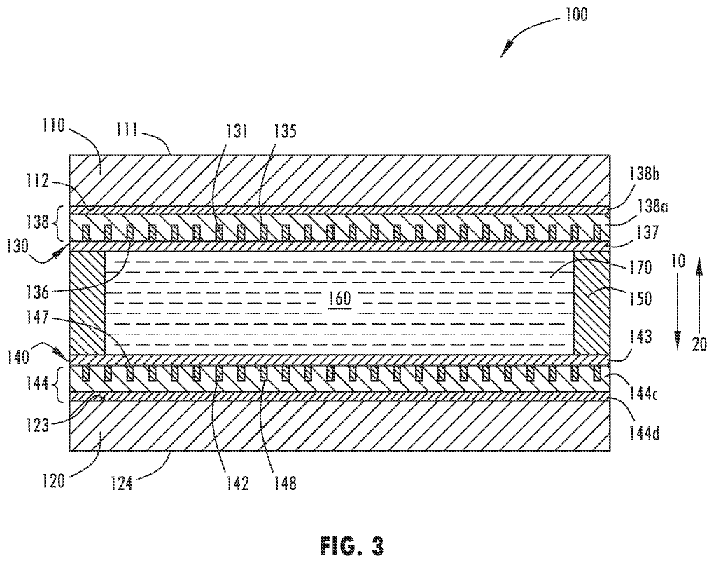

First electrode 130 is an electrically conductive member associated with second side 112. Thus, in some embodiments, first electrode 130 is disposed, at least in part, on second side 112. In some embodiments, as shown in FIG. 1, first electrode 130 may comprise a first mesh 131 and a first layer 137. In other embodiments, as shown in FIGS. 2-3, first electrode 130 may comprise a first mesh 131, a first layer 137, and/or a second layer 138. In some embodiments, first electrode 130 may be operable to have a substantially uniform electrical potential across and a substantially uniform current flow perpendicular relative second side 112. Additionally, in some embodiments of electro-optic element 100 and/or first substrate 110, after application of first electrode 130, either during electro-optic element 100 manufacturing or lifetime, first electrode 130 must tolerate a bend or flex. Accordingly, elements, such as first mesh 131 may have certain material properties or design characteristics to ensure the electrical distribution properties of first electrode 130 are maintained during such bending and/or flexing.

The flow of electricity may occur at a macro and a micro scale. The macro scale may correspond to electrical flow across an entirety of an extent of first electrode 130 relative second side 112. In other words, the macro distribution of electricity may ensure that all regions of first electrode 130 receive sufficient electrical flow. The micro distribution of electricity may correspond to a local distribution of electrical flow within a region. This may prevent small areas of non-uniform activation of electro-active medium 170 from occurring. Disruption of satisfactory distribution of electricity may be rooted in cracks in first mesh 131, contact resistance changes between first mesh 131 and first layer 137, and/or cracks or breaks in first layer 137. As such, appropriate materials should be selected accordingly for each element of first electrode 130. Ductility and malleability are terms used to distinguish from brittle metals. Brittle metals may fracture when a force is applied and the broken edged may be substantially fit together because of the lack of deformation. Accordingly, brittle metals or materials may have a risk of fracturing, which may lead to either macro or micro disruptions in the distribution of electricity and affect first electrode 130 and/or electro-optic element 100 performance. In contrast, ductile and/or malleable materials may stretch or deform before failure. Therefore, in embodiments where electro-optic element 100 and/or first substrate 110 are flexible, elements of first electrode 130 may be selected from ductile and/or malleable metals to reduce fracture.

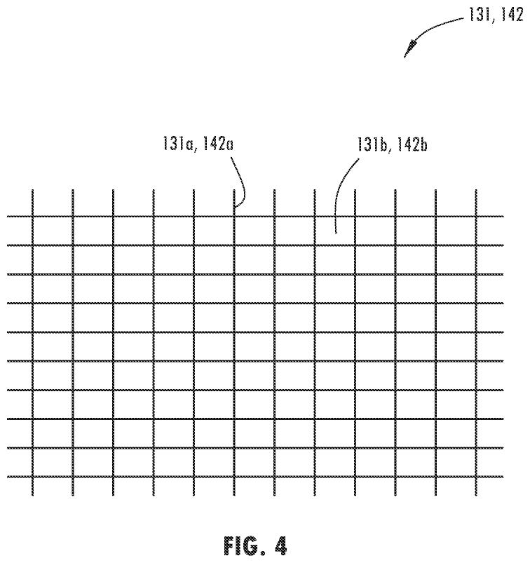

First mesh 131 is electrically conductive and may have a fifth side 135 and a sixth side 136. Fifth side 135 and sixth side 136 may be disposed opposite one another with sixth side 136 disposed in first direction 10 relative fifth side 135. In some embodiments, first mesh 131 may be in the form of a grid. The grid may present a network of connected tracings. These tracings may not be woven, and, in fact, may be connected as a single layer of tracings. Further, first mesh 131 may be comprised of metal. The metal may have a high conductivity. For example, the conductivity may be greater than or equal to 1.0×10⁷, 2.0×10⁷, 3.0×10⁷, 4.0×10⁷, 5.0×10⁷, or 6.0×10⁷ S/m. Thus, first mesh 131, for example, may be comprised of gold, silver, platinum, iron, nickel, copper, aluminum, or combinations thereof. Additionally, first mesh 131 mat be ductile. Accordingly, first mesh 131 may have an elongation to failure of at least 5%, an area reduction to rupture of at least 20%, and/or a true strain to rupture of at least 10%. Further, as shown in FIG. 4, first mesh 131 comprises a plurality of tracings 131a having open areas 131b between the tracings 131a. Accordingly, the plurality of tracings 131a may operate to provide the macro distribution of electricity across first electrode 130. Further, the tracings 131a may be arranged in any number of patterns, for example, tracings 131a may be arranged in a pattern of square, hexagonal, octagonal, circular, or sinusoidal features. A spacing between the features may be so small such as to not be visible to human eyes looking at electro-optic element 100. Accordingly, in some embodiments, the patterned features may generally be spaced by less than 300 microns. In other embodiments, the patterned features may generally be spaced less than about 500, 350, or 200 microns. Additionally, open areas 131b may account for greater than or equal to 60, 70, 80, or 90% of the area of first mesh 131. In some instances, a metal mesh may generate visual discomfort via the production of haze. Further, in extreme conditions, such as very bright or very dark backgrounds, the haze may be more profound by a sharp contrast. Accordingly, the surface morphology of first mesh 131 may be optimized to achieve clean edges and thus substantially eliminate angular refraction by first mesh 131. Therefore, the haze may be less than about 5.0, 2.5, 2.0, or 1.5 percent. A sheet resistance of first mesh 131 may be less than about 25.0, 10.0, 5.0, 2.0, or 0.5 ohms/sq. Additionally, repetitive patterns of first mesh 131 may result in diffraction patterns. Accordingly, first mesh 131 may be constructed in accordance with the teachings disclosed in U.S. Pat. No. 10,185,198, entitled “SECOND SURFACE LASER ABLATION,” which is herein incorporated by reference in its entirety, in order to keep diffraction patterns in acceptable levels. Therefore, the diffraction intensity may be less than or equal to about 5.0, 2.5, or 1.5. Further, the spatial frequency of the pattern of first mesh 131 may be randomized to reduce and/or minimize diffraction patterns and/or the dispersion of light caused by repetitive patterns. Moreover, first mesh 131 may have a Figure of Merit (FOM) greater than or equal to about 10, 50, 100, or 500. A FOM may be calculated by dividing transmittance by sheet resistance.

First layer 137 is substantially transparent and electrically conductive. Some examples of first layer 137 include transparent conductive oxides (TCO), such as fluorine doped tin oxide (FTO), indium-doped tin oxide (ITO), doped zinc oxide, or other materials known in the art. Other examples include so-called IMI structures, such as those disclosed in U.S. Pat. No. 7,830,583, entitled “ELECTRO-OPTICAL ELEMENT INCLUDING IMI COATINGS;” U.S. Pat. No. 8,368,992, entitled “ELECTRO-OPTICAL ELEMENT INCLUDING IMI COATINGS;” or U.S. Pat. No. 10,444,575, entitled “ELECTRO-OPTICAL ELEMENT WITH IMI LAYER,” the disclosures of which are herein incorporated by reference in their entireties. Yet other examples of first layer 137 may include silver nanowires; conductive polymers, such as Clevios™ which is commercially available from Heraeus of Hanau, Germany; carbon nanotubes; combinations thereof; or similar materials. Additionally, first layer 137 may be selected such that there is low contact resistance between first layer 137 and first mesh 131.

Second layer 138 is, similarly, a substantially transparent layer. In some embodiments, second layer 138 may be electrically conductive. Accordingly, second layer 138 may comprise a conductive polymer. Additionally, second layer 138 may comprise one or more sub-layers, such as a first sub-layer 138a. First sub-layer 138a may be electrically conductive. Accordingly, the conductive polymer may be comprised in first sub-layer 138a. Further, first sub layer 138 may be the furthest disposed layer of second layer 138 in first direction 10. One or more second sub-layer 138b may be disposed between first sub-layer 138a and first substrate 110. Accordingly, the second sub-layers 138b may be disposed in a second direction 20 relative first sub-layer 138a and in first direction 10 relative first substrate 110. Second direction 20 is a direction opposite first direction 10.

A second sub-layer 138b may be a hardcoat layer, such as those disclosed in U.S. Pat. App. 2019/0324341, entitled “PLASTIC COATINGS FOR IMPROVED SOLVENT RESISTANCE,” which is herein incorporated by reference in its entirety. A hardcoat layer may have a Shore D harness greater than or equal to 50, 55, 60, 65, 70, 75, or 80. Further, a hardcoat layer may have a Poisson's approximately between 0.2 and 0.4. Additionally, a hardcoat layer may be may be selected from acrylic polymer resins, siloxane based resins, polyethylene terephthalate (PET) resins, polyester resins, poly(methyl methacrylate) (PMMA), polycarbonate (PC) resins, or a combination thereof. In some aspects, second sub-layers 138b may be applied as a melted or flowing polymer system. In other aspects, second sub-layers 138b may be applied as a monomer or oligomeric system that is polymerized and/or crosslinked using UV light, E-beam, plasma, or any other initiation reaction known by those skilled in the art at atmospheric pressure or reduced pressure such as vacuum conditions. In some aspects, second sub-layers 138b may be applied as a monomer or oligomeric system that is cured, polymerized, and/or crosslinked using plasma, E-beam or beta radiation. In additional embodiments, second sub-layer 138b may be a multi-layer structure comprising a first hard coat layer, a ceramic layer, and/or a second hard coat layer. This structure may function as a barrier layer for oxygen, water, and/or other constituents. In yet another embodiment, second sub-layer 138b may comprise additional pairs of ceramic and hard coat layers creating a multi-layer structure with more layers. The layer furthest from first substrate 110 may be either a hard coat layer or a ceramic layer. In yet another embodiment, first mesh 131 may be embedded into a hard coat layer of second sub-layer 138b.

In embodiments where first electrode 130 comprises first mesh 131 and first layer 137, as show in FIG. 1, first mesh 131 may be disposed, at least in part, within first substrate 110. In some further embodiments, first mesh 131 may be further disposed such that sixth side 136 is substantially co-planar with second side 112. Accordingly, first substrate 110 may fully or substantially occupy one or more open areas 131b. First mesh 131 may be disposed within first substrate 110, for example, by: embossing, debossing, and/or ablating first substrate 110 to allow first mesh 131 to be fit into; pressing the tracings 131a of first mesh 131 directly into first substate 110; and/or forming first substrate 110 around the tracings 131a of first mesh 131. Further, first layer 137 may be associated with sixth side 136 and/or with second side 112. This association may serve to form an electrically communicative connection between first layer 137 and first mesh 131. In embodiments where sixth side 136 is substantially co-planar with second side 112, first layer 137 may accordingly be disposed such that it does not substantially extend into the open areas 131b.

In embodiments where first electrode 130 comprises first mesh 131, first layer 137, and second layer 138, as shown in FIGS. 2-3, second layer 138 may be associated with second surface 112. Accordingly, second layer 138 may be disposed on second surface 112. Further, first mesh 131 may be disposed, at least in part, within second layer 138. Thus, second layer 138 may fully or substantially occupy one or more open areas 131b. Additionally, first mesh 131 may be disposed in second layer 138 such that second layer 138 is disposed between first mesh 131 and first substrate 110. Therefore, first mesh 131 may not touch and be disposed in a spaced apart relationship relative first substrate 110. Accordingly, fifth side 135 may be disposed such that it is not substantially co-planar with and is in a spaced apart relationship relative second side 112. First mesh 131 may be disposed within second layer 138, for example, by: embossing, debossing, and/or second layer 138 to allow the tracings 131a of first mesh 131 to be fit there into; pressing the tracings 131a of first mesh 131 directly into second layer 138; and/or forming second layer 138 around the tracings 131a of first mesh 131. Further, first layer 137 may be associated with sixth side 136. This association may serve to form an electrically communicative connection between first layer 137 and first mesh 131.

Likewise, second electrode 140 is an electrically conductive member associated with third side 123. Thus, in some embodiments, second electrode 140 may be disposed, at least in part, on third side 123. In some embodiments, as shown in FIG. 1, second electrode 140 may comprise a second mesh 142 and a third layer 143. In other embodiments, as shown in FIGS. 2-3, second electrode 140 comprises a second mesh 142, a third layer 143, and a fourth layer 144. In some embodiments, second electrode 140 may be operable to have a substantially uniform electrical potential across and a substantially uniform current flow perpendicular relative third side 123. Additionally, in some embodiments of electro-optic element 100 and/or second substrate 110, after application of second electrode 140, either during electro-optic element 100 manufacturing or lifetime, second electrode 140 must tolerate a bend or flex. Accordingly, elements, such as second mesh 142 may have certain material properties or design characteristics to ensure the electrical distribution properties of second electrode 140 are maintained during such bending and/or flexing.

The flow of electricity may occur at a macro and a micro scale. The macro scale may correspond to electrical flow across an entirety of an extent of second electrode 140 relative second side 112. In other words, the macro distribution of electricity may ensure that all regions of second electrode 140 receive sufficient electrical flow. The micro distribution of electricity may correspond to a local distribution of electrical flow within a region. This may prevent small areas of non-uniform activation of electro-active medium 170 from occurring. Disruption of satisfactory distribution of electricity may be rooted in cracks in second mesh 142, contact resistance changes between second mesh 142 and third layer 143, and/or cracks or breaks in third layer 143. As such, appropriate materials must be selected for each element of second electrode 140. Ductility and malleability are terms used to distinguish from brittle metals. Brittle metals may fracture when a force is applied and the broken edged can be fit together because of the lack of deformation. Accordingly, brittle metals or materials may have a risk of fracturing, which may lead to either macro or micro disruptions in the distribution of electricity and affect second electrode 140 and/or electro-optic element 100 performance. In contrast, ductile and/or malleable materials may stretch or deform before failure. Therefore, in embodiments where electro-optic element 100 and/or second substrate 120 are flexible, elements of second electrode 140 may be selected from ductile and/or malleable metals to reduce fracture.

Second mesh 142 is electrically conductive and may have a seventh side 147 and an eighth side 148. Seventh side 147 and eighth side 148 may be disposed opposite one another with eighth side 148 disposed in first direction 10 relative seventh side 147. In some embodiments, second mesh 142 may be in the form of a grid. The grid may present a network of connected tracings. These tracings may not be woven, and, in fact, may be connected as a single layer of tracings. Further, second mesh 142 may be comprised of the same or similar materials as first mesh 131. Accordingly, second mesh 142 may be comprised of metal. The metal may have a high conductivity. For example, the conductivity may be greater than or equal to 1.0×10⁷, 2.0×10⁷, 3.0×10⁷, 4.0×10⁷, 5.0×10⁷, or 6.0×10⁷ S/m. Thus, second mesh 142, for example, may be comprised of gold, silver, platinum, iron, nickel, copper, aluminum, or combinations thereof. Additionally, first mesh 131 mat be ductile. Accordingly, first mesh 131 may have an elongation to failure of at least 5%, an area reduction to rupture of at least 20%, and/or a true strain to rupture of at least 10%. Further, as shown in FIG. 4, second mesh 142 comprises a plurality of tracings 142a having open areas 142b between tracings 142a. Accordingly, the plurality of tracings 142a may operate to provide the macro distribution of electricity across second electrode 140. Further, the tracings 142a may be arranged in any number of patterns, for example, tracings 142a may be arranged in a pattern of square, hexagonal, octagonal, circular, or sinusoidal features. A spacing between the features may be so small such as to not be visible to human eyes looking at electro-optic element 100. Accordingly, in some embodiments, the patterned features may generally be spaced by less than 300 microns. In other embodiments, the patterned features may generally be spaced less than about 500, 350, or 200 microns. Additionally, open areas 142b may account for greater than or equal to 60, 70, 80, or 90% of the area of second mesh 142. In some instances, a metal mesh may generate visual discomfort via the production of haze. Further, in extreme conditions, such as very bright or very dark backgrounds, the haze may be more profound by a sharp contrast. Accordingly, the surface morphology of second mesh 142 may be optimized to achieve clean edges and thus substantially eliminate angular refraction by second mesh 142. Therefore, the haze may be less than about 5.0, 2.5, 2.0, or 1.5 percent. A sheet resistance of second mesh 142 may be less than about 25.0, 10.0, 5.0, 2.0, or 0.5 ohms/sq. Additionally, repetitive patterns of second mesh 142 may result in diffraction patterns. Accordingly, second mesh 142 may be constructed in accordance with the teachings disclosed in U.S. Pat. No. 10,185,198, entitled “SECOND SURFACE LASER ABLATION,” which is herein incorporated by reference in its entirety, in order to keep diffraction patterns in acceptable levels. Therefore, the diffraction intensity may be less than or equal to about 5.0, 2.5, or 1.5. Further, the spatial frequency of the pattern of second mesh 142 may be randomized to reduce and/or minimize diffraction patterns and/or the dispersion of light caused by repetitive patterns. Moreover, second mesh 142 may have a Figure of Merit (FOM) greater than or equal to about 10, 50, 100, or 500. A FOM may be calculated by dividing transmittance by sheet resistance.

Third layer 143 is substantially transparent and electrically conductive. Accordingly, third layer 143 may be comprised of the same or similar materials as first layer 137. Some examples of third layer 143 include transparent conductive oxides (TCO), such as fluorine doped tin oxide (FTO), indium-doped tin oxide (ITO), doped zinc oxide, or other materials known in the art. Other examples include so-called IMI structures, such as those disclosed in U.S. Pat. No. 7,830,583, entitled “ELECTRO-OPTICAL ELEMENT INCLUDING IMI COATINGS;” U.S. Pat. No. 8,368,992, entitled “ELECTRO-OPTICAL ELEMENT INCLUDING IMI COATINGS;” or U.S. Pat. No. 10,444,575, entitled “ELECTRO-OPTICAL ELEMENT WITH IMI LAYER,” the disclosures of which are herein incorporated by reference in their entireties. Yet other examples of third layer 143 may include silver nanowires, conductive polymers, carbon nanotubes, or similar materials. Additionally, third layer 143 may be selected such that there is low contact resistance between third layer 143 and second mesh 142.

Fourth layer 144 is, similarly, a substantially transparent layer. In some embodiments, fourth layer 144 may be electrically conductive. Accordingly, fourth layer 144 may comprise a conductive polymer. Additionally, fourth layer 144 may comprise one or more sub-layers, such as a third sub-layer 144c. In some embodiments, third sub-layer 144c may be electrically conductive. Accordingly, the conductive polymer may be comprised in third sub-layer 144c. Further, third sub-layer 144c may be the furthest disposed sub-layer of second layer 138 in second direction 20. One or more fourth sub-layer 144d may be disposed between third sub-layer 144c and second substrate 120. Accordingly, the fourth sub-layers 144d may be disposed in the first direction 10 relative third sub-layer 144c and in the second direction 20 relative second substrate 120.

A fourth sub-layer 144d may be a hardcoat layer, such as those disclosed in U.S. Pat. App. 2019/0324341, entitled “PLASTIC COATINGS FOR IMPROVED SOLVENT RESISTANCE,” which is herein incorporated by reference in its entirety. A hardcoat layer may have a Shore D harness greater than or equal to 50, 55, 60, 65, 70, 75, or 80. Further, a hardcoat layer may have a Poisson's approximately between 0.2 and 0.4. Additionally, a hardcoat layer may be may be selected from acrylic polymer resins, siloxane based resins, polyethylene terephthalate (PET) resins, polyester resins, poly(methyl methacrylate) (PMMA), polycarbonate (PC) resins, or a combination thereof. In some aspects, fourth sub-layers 144d may be applied as a melted or flowing polymer system. In other aspects, fourth sub-layers 144d may be applied as a monomer or oligomeric system that is polymerized and/or crosslinked using UV light, E-beam, plasma, or any other initiation reaction known by those skilled in the art at atmospheric pressure or reduced pressure such as vacuum conditions. In some aspects, fourth sub-layers 144d may be applied as a monomer or oligomeric system that is cured, polymerized, and/or crosslinked using plasma, E-beam or beta radiation. In additional embodiments, fourth sub-layer 144d may be a multi-layer structure comprising a first hard coat layer, a ceramic layer, and/or a second hard coat layer. This structure may function as a barrier layer for oxygen, water, and/or other constituents. In yet another embodiment, fourth sub-layer 144d may comprise additional pairs of ceramic and hard coat layers creating a multi-layer structure with more layers. The layer furthest from second substrate 120 may be either a hard coat layer or a ceramic layer. In yet another embodiment, second mesh 142 may be embedded into a hard coat layer of fourth sub-layer 144d.

In embodiments where second electrode 140 comprises second mesh 142 and third layer 143, as show in FIG. 1, second mesh 142 may be disposed, at least in part, within second substrate 120. In some further embodiments, second mesh 142 may be further disposed such that seventh side 147 is substantially co-planar with third side 123. Accordingly, second substrate 120 may substantially occupy one or more open areas 142b. Second mesh 142 may be disposed within second substrate 120, for example, by: embossing, debossing, and/or ablating second substrate 110 to provide features for the tracings 142a of second mesh 142 to be fit into; pressing the tracings 142a of second mesh 142 directly into second substrate 120; and/or forming second substrate 120 around the tracings 142a of second mesh 142. Further, third layer 143 may be associated with seventh side 147 and/or with third side 123. This association may serve to form an electrically communicative connection between third layer 143 and second mesh 142. In embodiments where seventh side 147 is substantially co-planar with third side 123, third layer 143 may accordingly be disposed such that it does not substantially extend into the open areas 142b.

In embodiments where second electrode 140 comprises second mesh 142, third layer 143, and fourth layer 144, as shown in FIGS. 2-3, fourth layer 144 may be associated with third surface 123. Accordingly, fourth layer 144 may be disposed on third surface 123. Further, second mesh 142 may be disposed, at least in part, within fourth layer 144. Thus, fourth layer 144 may substantially occupy one or more open areas 142b. Additionally, second mesh 142 may be disposed in fourth layer 144 such that fourth layer 144 is disposed between second mesh 142 and second substrate 120. Therefore, second mesh 142 may not touch and be disposed in a spaced apart relationship relative second substrate 120. Accordingly, eighth side 148 may be disposed such that it is not substantially co-planar with and is in a spaced apart relationship relative third side 123. Second mesh 142 may be disposed within fourth layer 144, for example, by: embossing, debos sing, and/or fourth layer 144 to allow the tracings 142a of second mesh 142 to be fit there into; pressing the tracings 142a of second mesh 142 directly into fourth layer 144; and/or forming fourth layer 144 around the tracings 142a of second mesh 142. Further, third layer 143 may be associated with seventh side 147. This association may serve to form an electrically communicative connection between third layer 143 and second mesh 142.

Seal 150 may be disposed in a peripheral manner to define a chamber 160 between first substrate 110 and second substrate 120. Chamber 160 may be defined by seal 150 in conjunction with at least two of: first substrate 110, second substrate 120, first electrode 130, and second electrode 140. In some embodiments, chamber 150 may, more specifically, be defined by seal 150, first electrode 130, and second electrode 140. Seal 150 may comprise any material capable of being bonded to the at least two of: first substrate 110, second substrate 120, first electrode 130, and second electrode 140, to in turn inhibit oxygen and/or moisture from entering chamber 160, as well as inhibit electro-active medium 170 from inadvertently leaking out. Seal 150, for example, may include epoxies, urethanes, cyanoacrylates, acrylics, polyimides, polyamides, poly sulfides, phenoxy resin, polyolefins, and silicones.

Electro-active medium 170 is disposed in chamber 160. Further, electro-active medium 170 is operable between activated and un-activated states in response to an electrical potential. Accordingly, electro-active medium 170 may include, among other materials, electro-active anodic and cathodic materials. Additionally, electro-active medium 170 may comprise one or more solvent. In some embodiments, the anodic and/or cathodic materials may be electro-optic and/or electrochromic. Accordingly, in some embodiments, upon activation, due to the application of an electronic voltage or potential, electro-active medium 170 may exhibit a change in absorbance at one or more wavelengths of the electromagnetic spectrum. Therefore, electro-active medium 170 may be variably transmissive. The change in absorbance may be in the visible, ultra-violet, infra-red, and/or near infra-red regions. In other embodiments, electro-active medium 170 may be a liquid crystal medium or a suspended particle medium. Electro-active medium 170 may be fabricated from any one of a number of materials, including, for example, those disclosed in U.S. Pat. No. 6,433,914, entitled “Color-Stabilized Electrochromic Devices,” which is herein incorporated by reference in its entirety.

In operation, an electrical potential may be applied across the first and second electrodes 130, 140. Accordingly, electro-active medium 170 may operate between an un-activated state and an activated state. Specifically, the electrical potential may be applied across first mesh 131 and second mesh 142. Each mesh 131, 142, may operate to distribute electrons of the electrical current in an efficient manner to areas of the first and second electrodes 130, 140, respectively. This distribution may be characterized as a global distribution. Subsequently and advantageously, the first layer 137 and/or the third layer 143 may serve to laterally distribute the electrical current from the first and second meshes 131, 142, respectively, such that the electrical potential is substantially uniform across the first and second electrodes 130, 140, respectively. For example, the first layer 137 and/or the third layer 143 may distribute the electrons to or from the first and second meshes 131, 142, in a more localized manner. Accordingly, the electrons may be locally distributed within areas of the first and second electrodes 130, 140, respectively, corresponding to the open areas 131b, 142b of the respective first and second meshes 131, 142. This may in turn increase uniformity in the activation of electro-active medium 170 across chamber 160. Additionally, the first layer 137 and/or the third layer 143 may help to enhance and/or preserve lateral uniformity of the electrical potential across chamber 160 by allowing electrons to bypass defects of the first and second meshes 131, 142, via the first layer 137 and/or third layer 143, respectively.

Furthermore, some of the disclosed embodiments, such as those illustrated in FIG. 1, enable the first and/or second meshes 131, 142 to be embedded into the first and second substrates 110, 120, respectively, thereby increasing adhesion there between, while ensuring electrical potential distribution across the open areas 131b, 142b. The adhesion may be increased due to an increased surface area contact between the first and/or second meshes 131, 142 and the respective first and second substrates 110, 120. If the first and/or second meshes 131, 142 were associated with the respective first and second substrates 110, 120 simply via contact with the fifth and eighth surfaces 135, 148, respectively, an inferior adhesion may result.

Similarly, other disclosed embodiments, such as those illustrated in FIGS. 2-3, also may provide increased adhesion between the first and/or second meshes 131, 142 and the respective first and second substrates 110, 120, relative the first and/or second meshes 131, 142 being associated with the respective first and second substrates 110, 120 simply via contact with the fifth and eighth surfaces 135, 148, respectively. The adhesion may be increased by disposing a portion of the second and/or fourth layers 138, 144 and or disposing a hard coat layer, such as the second and fourth sub-layers 138b, 144d between the first and/or second meshes 131, 142 and the first and second substrates 110, 120, respectively. The second and/or fourth layers 138, 144 and/or the second and fourth sub-layers 138b, 144d may be comprised of a material that operably is better adhered to the first and second substrates 110, 120, respectively. Further, the first and/or second meshes 131, 142 may have an increased adhesion with the second and/or fourth layers 138, 144 and/or the first and third sub-layers 138a, 144c due to their disposition therein. Furthermore, all the while, electrical potential distribution across the open areas 131b, 142b is ensured by the association of the first and/or second meshes 131, 142 and the first and/or third layers 137, 143, respectively.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; A and C in combination; B and C in combination; or A, B, and C in combination.

In this document, relational terms, such as “first,” “second,” and the like, are used solely to distinguish one entity or action from another entity or action, without necessarily requiring or implying any actual such relationship or order between such entities or actions.

For purposes of this disclosure, the term “associated” generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The term “substantially,” and variations thereof, will be understood by persons of ordinary skill in the art as describing a feature that is equal or approximately equal to a value or description. For example, a “substantially planar” surface is intended to denote a surface that is planar or approximately planar. Moreover, “substantially” is intended to denote that two values are equal or approximately equal. If there are uses of the term which are not clear to persons of ordinary skill in the art, given the context in which it is used, “substantially” may denote values within about 10% of each other, such as within about 5% of each other, or within about 2% of each other.

The term “transparent” is applied in the relative sense. “Transparent” refers to an optical element or material that is substantially transmissive of at wavelengths in question and thus generally allows light at such wavelengths to pass therethrough. The wavelengths in question will vary based on the context. However, in the event the wavelengths in question is not readily apparent, the wavelengths in question shall generally refer to visible light.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

What is claimed is:

1. A device comprising:
a first flexible substrate having a first side and a second side;
a second flexible substrate having a third side and a fourth side, the second flexible substrate disposed in a spaced apart relationship relative the first flexible substrate where the third side faces the second side;
a first electrode associated with the second side, the first electrode comprising:
a first electrically conductive mesh disposed, at least in part, within the first flexible substrate, and
a first substantially transparent, electrically conductive layer associated with the second side;
a second electrode associated with the third side; and
an electro-active medium disposed between the first and second electrodes, the electro-active medium operable between an activated state and an un-activated state.

2. The device of claim 1, wherein the first electrically conductive mesh has a fifth side and a sixth side and the sixth side is substantially co-planar with the second side.

3. The device of claim 2, wherein the first substantially transparent, electrically conductive layer is disposed, at least in part, on the sixth side.

4. The device of claim 1, wherein the first flexible substrate is a conductive polymer.

5. The device of claim 1, wherein the second electrode comprises:
a second electrically conductive mesh disposed, at least in part, within the second flexible substrate; and
a second substantially transparent, electrically conductive layer associated with the third side.

6. The device of claim 1, wherein the electro-active medium is electro-optic.

7. The device of claim 6, wherein the electro-active medium is electrochromic.

8. The device of claim 1, further comprising a third substantially transparent substrate associated with the first side.

9. The device of claim 8, further comprising a third layer disposed between the first substrate and the third substrate.

10. The device of claim 8, further comprising a fourth substantially transparent substrate associated with the fourth side.

11. The device of claim 1, wherein the first substantially transparent, electrically conductive layer is selected from at least one of TCO, IMI, conductive polymer, carbon nanotube, and silver nanowire materials.

12. The device of claim 1, wherein the first electrically conductive mesh has an elongation failure of at least 5%.

13. The device of claim 1, wherein the first electrically conductive mesh has an area reduction to rupture of at least 20%.

14. The device of claim 1, wherein the first electrically conductive mesh has a stretch rupture of at least 10%.

15. The device of claim 1, wherein the first flexible substrate substantially fully occupies one or more open areas of the first electrically conductive mesh.

16. A device comprising:
a first flexible substrate having a first side and a second side;
a second flexible substrate having a third side and a fourth side, the second flexible substrate disposed in a spaced apart relationship relative the first flexible substrate where the third side faces the second side;
a first electrode associated with the second side, the first electrode comprising:
a first electrically conductive mesh having a fifth side and a sixth side,
a first layer disposed between the first substrate and the first mesh, the first layer being substantially transparent,
a second layer associated with the sixth side, the second layer being substantially transparent and electrically conductive,
a second electrode associated with the third side; and
an electro-active medium disposed between the first and second electrodes, the electro-active medium operable between an activated state and an un-activated state.

17. The device of claim 16, wherein the first mesh is disposed, at least in part, within the first layer.

18. The device of claim 16, wherein the first layer is a conductive polymer.

19. The device of claim 16, wherein the second electrode comprises:
a second electrically conductive mesh having a seventh side and an eighth side;
a third layer disposed between the second substrate and the second mesh, the third layer being substantially transparent; and
a fourth layer associated with the seventh side, the fourth layer being substantially transparent and electrically conductive.

20. The device of claim 16, wherein the electro-active medium is electro-optic.
